(19) United States
(12) Patent Application Publication
(10) Pub. No.: US 2010/0158324 A1
(43) Pub. Date: Jun. 24, 2010

(54) METHOD FOR ADJUSTING LIGHT SOURCE THRESHOLD VALUE FOR FACE RECOGNITION

(75) Inventor: Yung-Chou LIU, Taipei City (TW)

Correspondence Address: RABIN & Berdo, PC, 1101 14TH STREET, NW, SUITE 500, WASHINGTON, DC, 20005, US

(73) Assignee: MICRO-STAR INTERNATIONA'L CO., LTD., Taipei County (TW)

(21) Appl. No.: 12/437,712

(22) Filed: May 8, 2009

(30) Foreign Application Priority Data
Dec. 19, 2008 (TW) 097149873

(51) Int. Cl. G06K 9/00

(52) U.S. Cl. 382/118; 382/190; 382/274

(57) ABSTRACT

A method for adjusting a light source threshold value for face recognition is presented, including capturing an input image; calculating a first brightness value of the input image; loading a target image; loading a second brightness value of the target image; comparing the first brightness value with the second brightness value to obtain a brightness difference value between the input image and the target image; adjusting a basic threshold value according to the brightness difference value to obtain a recognition threshold value; and performing a face recognition process on the input image by using the recognition threshold value.

### CROSS-REFERENCE TO RELATED APPLICATIONS

This non-provisional application claims priority under 35 U.S.C. §119(a) on Patent Application No(s). 097149873 filed in Taiwan, R.O.C. on Dec. 19, 2008 the entire contents of which are hereby incorporated by reference.

### BACKGROUND

1. Field of Invention

The present invention relates to a method for face recognition, and more particularly to a method for adjusting a light source threshold value for face recognition.

2. Related Art

In a face recognition technology, a face recognition process can be performed as long as the face of a user is in an effective capturing distance of an electronic device having an image capturing function and the electronic device captures an image of the face of the user.

When applied to an electronic device, face recognition is based on the result of a series of algorithms and image value calculations performed by the electronic device. The electronic device compares an input image of the user with a target image stored in a storage device and calculates a value. The value is used to represent an image similarity value of the user in face recognition. In addition, a basic threshold value is set in the electronic device for determining whether the image similarity value meets recognition criteria in a face recognition process or not.

The input image of the user captured by the electronic device is usually quite different from the actual face image of the user due to different ambient light sources. Since an external light source may cause changes in shadows on the face of the user, the calculated image similarity value changes greatly, resulting in that the image similarity value cannot meet criteria for the basic threshold value and thus the user cannot pass recognition. Therefore, the face recognition process of the electronic device is susceptible to ambient light sources, which reduces the effect of recognition and causes a lot of inconvenience to operations of the user.

### SUMMARY

Accordingly, the present invention is directed to a method for adjusting a light source threshold value for face recognition, so as to dynamically adjust a basic threshold value for face recognition under different ambient light sources.

Therefore, a method for adjusting a light source threshold value for face recognition disclosed by the present invention includes: capturing an input image; calculating a first brightness value of the input image; loading a target image; loading a second brightness value of the target image; comparing the first brightness value with the second brightness value to obtain a brightness difference value between the input image and the target image; adjusting a basic threshold value according to the brightness difference value to obtain a recognition threshold value; and performing a face recognition process on the input image by using the recognition threshold value.

The first brightness value may include a brightness average value and a brightness standard deviation value of the input image, and the second brightness value may include a brightness average value and a brightness standard deviation value of the target image.

In addition, the brightness average value of the input image may be calculated by using the following equation:

$$\overline{x} = \frac{1}{N} {\sum }_{i = 1}^{N} {x}_{i} .$$

In this equation, x̅ is the brightness average value of the input image, N is a total number of pixels of the input image, i is an i^{th} pixel of the input image, xᵢ is a brightness value of the i^{th} pixel of the input image, and N and i are positive integers.

The brightness average value of the target image may be calculated by using the following equation:

$$\overline{y} = \frac{1}{M} {\sum }_{j = 1}^{M} {y}_{j} .$$

In this equation, y̅ is the brightness average value of the target image, M is a total number of pixels of the target image, j is a j^{th} pixel of the target image, yⱼ is a brightness value of the j^{th} pixel of the target image, and M and j are positive integers.

In addition, the brightness standard deviation value of the input image may be calculated by using the following equation:

$$σ = \sqrt{\frac{1}{N} {\sum }_{i = 1}^{N} {( {x}_{i} - \overline{x} )}^{2}} .$$

In this equation, σ is the brightness standard deviation value of the input image, N is the total number of pixels of the input image, i is the i^{th} pixel of the input image, xᵢ is the brightness value of the i^{th} pixel of the input image, x̅ is the brightness average value of the input image, and N and i are positive integers.

The brightness standard deviation value of the target image may be calculated by using the following equation:

$$θ = \sqrt{\frac{1}{M} {\sum }_{j = 1}^{M} {( {y}_{j} - \overline{y} )}^{2}} .$$

In this equation, θ is the brightness standard deviation value of the target image, M is the total number of pixels of the target image, j is the j^{th} pixel of the target image, yⱼ is the brightness value of the j^{th} pixel of the target image, y̅ is the brightness average value of the target image, and M and j are positive integers.

Furthermore, before the step of loading the target image and the step of loading the second brightness value of the target image, the method further includes: capturing the target image; calculating the second brightness value of the shot target image; and storing the shot target image and the calculated second brightness value.

In addition, before the step of comparing the first brightness value with the second brightness value to obtain the brightness difference value between the input image and the target image, the method may include: comparing the brightness average value in the first brightness value with the brightness average value in the second brightness value to obtain a first difference value; comparing the brightness standard deviation value in the first brightness value with the brightness standard deviation value in the second brightness value to obtain a second difference value; and calculating the brightness difference value between the input image and the target image according to the first difference value and the second difference value.

Furthermore, the step of adjusting the basic threshold value according to the brightness difference value to obtain the recognition threshold value may include: looking up a first lookup table according to the brightness difference value to obtain a first compensation value corresponding to the brightness difference value; looking up a second lookup table according to the brightness difference value to obtain a second compensation value corresponding to the brightness difference value; calculating a threshold compensation value according the first compensation value and the second compensation value; and adjusting the basic threshold value with the threshold compensation value to obtain the recognition threshold value.

The step of calculating the threshold compensation value according to the first compensation value and the second compensation value may include: summing the first compensation value and the second compensation value to obtain the threshold compensation value.

Here, the first compensation value is associated with the brightness average value of the input image, and the second compensation value is associated with the brightness standard deviation value of the input image.

Furthermore, before the step of adjusting the basic threshold value, the method may further include: setting the basic threshold value.

At last, the face recognition process may include: detecting a first face block in the input image; detecting a second face block in the target image; calculating the detected first face block and the detected second face block to obtain an image similarity value; and comparing the recognition threshold value with the image similarity value to determine whether the input image passes the face recognition process or not.

When the method for adjusting a light source threshold value for face recognition provided by the present invention is applied to a face recognition system, the recognition threshold value for face recognition can be dynamically adjusted under different ambient light sources. No matter the ambient light is poor or the image brightness difference recorded in a database is too big, the recognition threshold value can be properly increased or decreased, so as to enable a user to successfully complete a face recognition under different environments and different lights.

### BRIEF DESCRIPTION OF THE DRAWINGS

The present invention will become more fully understood from the detailed description given herein below for illustration only, and thus are not limitative of the present invention, and wherein:

FIG. 1 is a flow chart of a method for adjusting a light source threshold value for face recognition according to an embodiment of the present invention.

FIG. 2 is a detailed flow chart of a step of capturing a target image in a method for adjusting a light source threshold value for face recognition according to an embodiment of the present invention.

FIG. 3 is a detailed flow chart of a step of comparing a brightness difference value between an input image and a target image in a method for adjusting a light source threshold value for face recognition according to an embodiment of the present invention.

FIG. 4 is a detailed flow chart of a step of adjusting a basic threshold value to obtain a recognition threshold value in a method for adjusting a light source threshold value for face recognition according to an embodiment of the present invention.

FIG. 5 is a detailed flow chart of a step of calculating a threshold compensation value in a method for adjusting a light source threshold value for face recognition according to an embodiment of the present invention.

FIG. 6 is a detailed flow chart of a face recognition process in a method for adjusting a light source threshold value for face recognition according to an embodiment of the present invention.

### DETAILED DESCRIPTION OF THE INVENTION

A method for adjusting a light source threshold value for face recognition according to the present invention is applied to an electronic device having an image capturing function. The method may be built in a storage device of the electronic device through software or firmware, such that a processor of the electronic device executes the built-in software or firmware to achieve the method for adjusting a light source threshold value for face recognition according to the present invention in combination with the image capturing function. Here, the electronic device may be, but not limited to, a computer with the image capturing function, a mobile phone with the image capturing function, or a personal digital assistant (PDA) with the image capturing function.

In the present invention, firstly, an input image is compared with a target image to obtain a brightness difference value, and a basic threshold value is dynamically adjusted according to the brightness difference value to obtain a recognition threshold value; and then, a face recognition process is performed on the input image by using the obtained recognition threshold value.

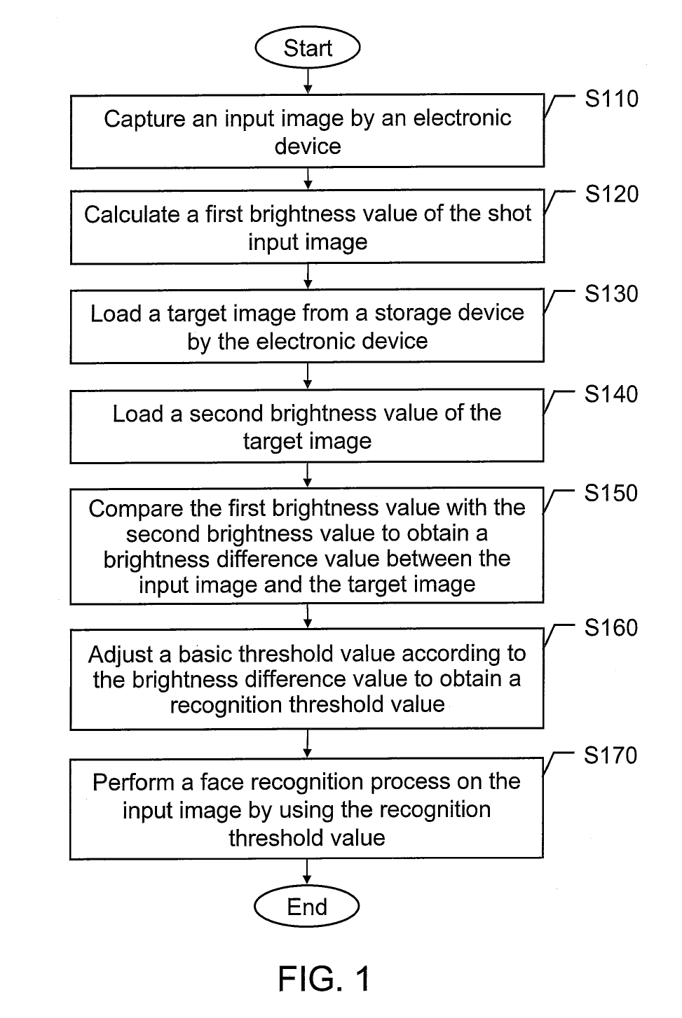

FIG. 1 is a flow chart of a method for adjusting a light source threshold value for face recognition according to an embodiment of the present invention.

Referring to FIG. 1, when an electronic device receives a face recognition instruction, at first, the electronic device captures an input image (Step S110), and calculates a first brightness value of the shot input image (Step S120). Then, the electronic device loads a target image from a storage device (Step S130), and loads a second brightness value of the target image (Step S140). The first brightness value is compared with the second brightness value to obtain a brightness difference value between the input image and the target image (Step S150). Here, a basic threshold value is adjusted according to the brightness difference value to obtain a recognition threshold value (Step S160). At last, a face recognition process is performed on the input image by using the recognition threshold value (Step S170).

The first brightness value includes a brightness average value and a brightness standard deviation value of the input image, and the second brightness value may include a brightness average value and a brightness standard deviation value of the target image.

Here, the brightness average value of the input image may be calculated by using the following equation:

$$\overline{x} = \frac{1}{N} {\sum }_{i = 1}^{N} {x}_{i} .$$

In this equation, x̅ is the brightness average value of the input image, N is a total number of pixels of the input image, i is an i^{th} pixel of the input image, xᵢ is a brightness value of the i^{th} pixel of the input image, and N and i are positive integers.

The brightness average value of the target image may be calculated by using the following equation:

$$\overline{y} = \frac{1}{M} {\sum }_{j = 1}^{M} {y}_{j} .$$

In this equation, y̅ is the brightness average value of the target image, M is a total number of pixels of the target image, j is a j^{th} pixel of the target image, yⱼ is a brightness value of the j^{th} pixel of the target image, and M and j are positive integers.

In addition, the brightness standard deviation value of the input image may be calculated by using the following equation:

$$σ = \sqrt{\frac{1}{N} {\sum }_{i = 1}^{N} {( {x}_{i} - \overline{x} )}^{2}} .$$

In this equation, σ is the brightness standard deviation value of the input image, N is the total number of pixels of the input image, i is the i^{th} pixel of the input image, xᵢ is the brightness value of the i^{th} pixel of the input image, x̅ is the brightness average value of the input image, and N and i are positive integers.

The brightness standard deviation value of the target image may be calculated by using the following equation:

$$θ = \sqrt{\frac{1}{M} {\sum }_{j = 1}^{M} {( {y}_{j} - \overline{y} )}^{2}} .$$

In this equation, θ is the brightness standard deviation value of the target image, M is the total number of pixels of the target image, j is the j^{th} pixel of the target image, yᵢ is the brightness value of the j^{th} pixel of the target image, y̅ is the brightness average value of the target image, and M and j are positive integers.

Here, before Step S130 and Step S140, the method may further include the following implementation steps.

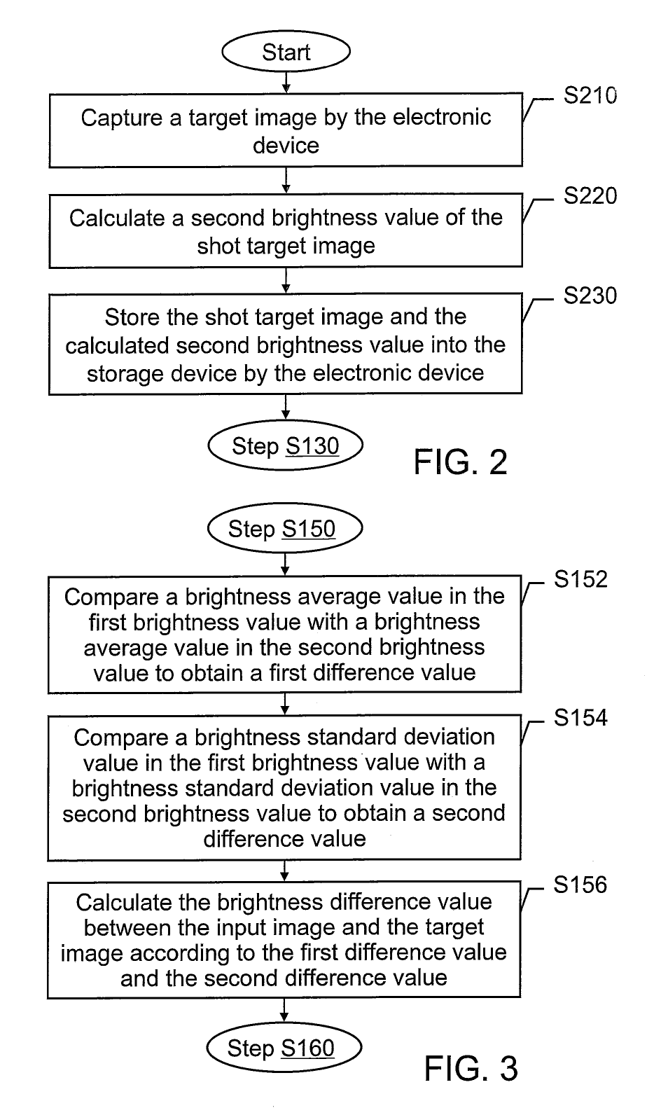

Referring to FIG. 2, at first, the electronic device captures a target image (Step S210), and calculates a second brightness value of the shot target image (Step S220). Then, the electronic device stores the shot target image and the calculated second brightness value into a storage device (Step S230).

Here, the brightness average value of the target image may be calculated by using the following equation:

$$\overline{y} = \frac{1}{M} {\sum }_{j = 1}^{M} {y}_{j} .$$

In this equation, y̅ is the brightness average value of the target image, M is a total number of pixels of the target image, j is a j^{th} pixel of the target image, yⱼ is a brightness value of the j^{th} pixel of the target image, and M and j are positive integers.

The brightness standard deviation value of the target image may be calculated by using the following equation:

$$θ = \sqrt{\frac{1}{M} {\sum }_{j = 1}^{M} {( {y}_{j} - \overline{y} )}^{2}} .$$

In this equation, θ is the brightness standard deviation value of the target image, M is the total number of pixels of the target image, j is the j^{th} pixel of the target image, yⱼ is the brightness value of the j^{th} pixel of the target image, y̅ is the brightness average value of the target image, and M and j are positive integers.

Furthermore, Step S150 may include the following implementation steps.

Referring to FIG. 3, at first, the brightness average value in the first brightness value is compared with the brightness average value in the second brightness value to obtain a first difference value (Step S152). Then, the brightness standard deviation value in the first brightness value is compared with the brightness deviation value in the second brightness value to obtain a second difference value (Step S154). At last, the brightness difference value between the input image and the target image is calculated according to the first difference value and the second difference value (Step S156).

In addition, Step S160 may include the following implementation steps.

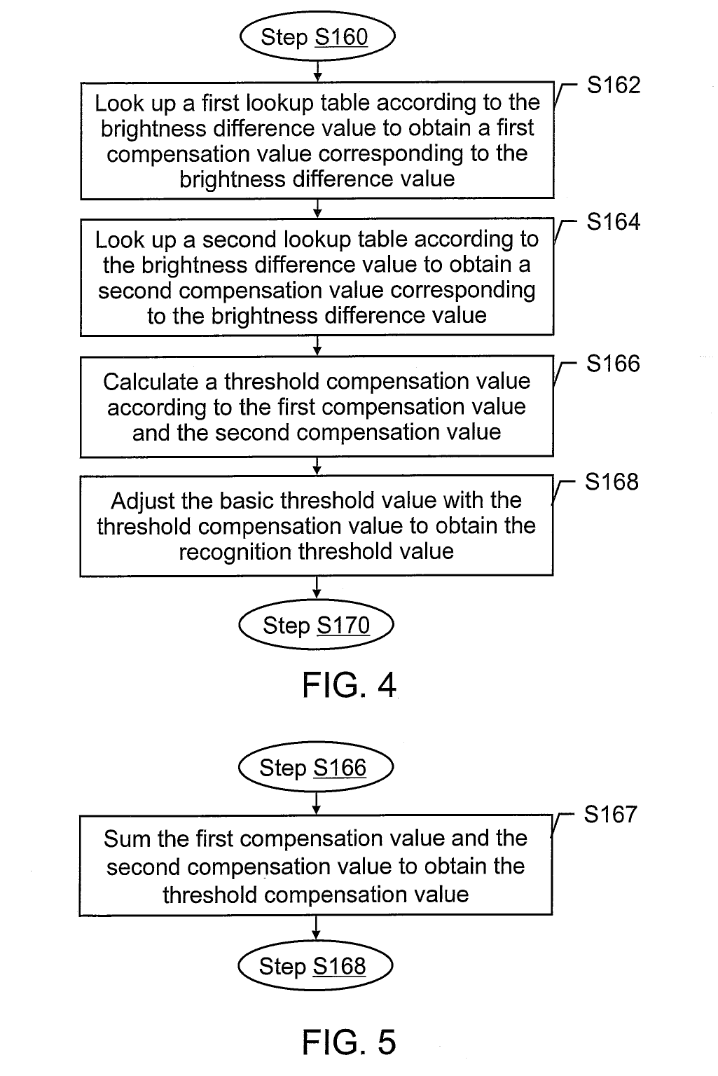

Referring to FIG. 4, at first, a first lookup table is looked up according to the brightness difference value to obtain a first compensation value corresponding to the brightness difference value (Step S162). Then, a second lookup table is looked up according to the brightness difference value to obtain a second compensation value corresponding to the brightness difference value (Step S164). Afterward, a threshold compensation value is calculated according to the first compensation value and the second compensation value (Step S166). At last, the basic threshold value is adjusted with the threshold compensation value to obtain the recognition threshold value (Step S168).

Table 1 is the first lookup table according to an embodiment of the present invention, which shows the first compensation value corresponding to the first difference value in the brightness difference value. Table 2 is the second lookup table according to an embodiment of the present invention, which shows the second compensation value corresponding to the second difference value in the brightness difference value.

TABLE 1

Name

| | First difference | |
|---|---|---|
| | value β of the brightness | First compensation |
| Item | difference value | value |
| 1 | 0 < \|β\| ≦ 15 | 0 |
| 2 | 15 < \|β\| | 0.5 |

TABLE 2

Name

| | Second difference | |
|---|---|---|
| | value γ of the | Second compensation |
| Item | brightness difference value | value |
| 1 | 5 < \|γ\| ≦ 9 | 1.0 |
| 2 | 9 < \|γ\| ≦ 13 | 2.0 |
| 3 | 13 < \|γ\| ≦ 20 | 3.0 |
| 4 | 20 < \|γ\| | 3.5 |

Step S166 may include the following implementation steps.

Referring to FIG. 5, the first compensation value and the second compensation value are summed to obtain the threshold compensation value (Step S167).

In addition, the first compensation value is associated with the brightness average value of the input image, and the second compensation value is associated with the brightness standard deviation value of the input image.

Furthermore, a basic threshold value may be preset in the electronic device for comparing with the brightness difference value between the input image and the target image in the process of performing the face recognition process.

At last, Step S170 may include the following implementation steps.

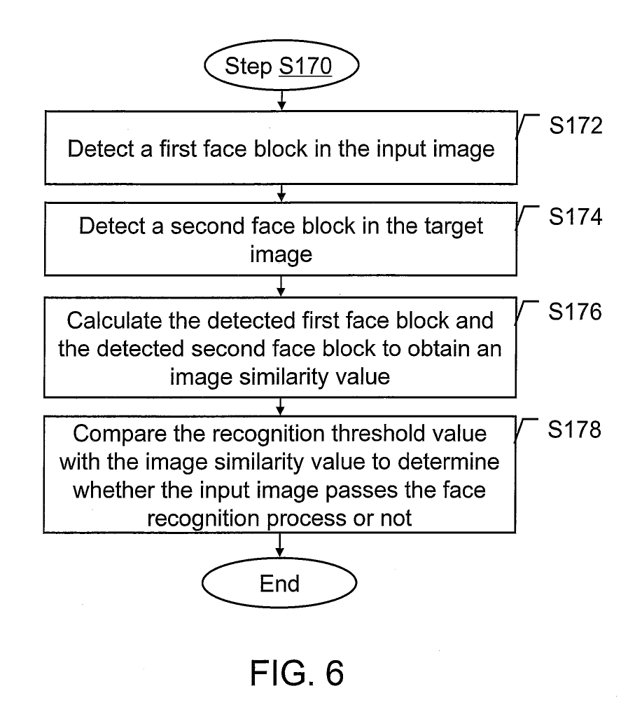

Referring to FIG. 6, at first, a first face block in the input image is detected (Step S172). Then, a second face block in the target image is detected (Step S174). The detected first face block and the detected second face block are calculated to obtain an image similarity value (Step S176). At last, the recognition threshold value is compared with the image similarity value to determine whether the input image passes the face recognition process or not (Step S178).

For example, when the electronic device receives a face recognition instruction, at first, the electronic device captures an input image, and calculates a first brightness value of the shot input image. For ease of description, it is assumed that a brightness average value in the first brightness value is 64, a standard deviation value in the first brightness value is 18. Then, the electronic device loads a target image from the storage device, and loads a second brightness value of the target image. For ease of description, it is assumed that a brightness average value in the second brightness value is 86, and a standard deviation value in the second brightness value is 33. The brightness average value 64 in the first brightness value is compared with the brightness average value 86 in the second brightness value to obtain a first difference value 64−86=−22. The brightness standard deviation value 18 in the first brightness value is compared with the brightness standard deviation value 33 in the second brightness value to obtain a second difference value 18−33=−15. At last, the brightness difference value between the input image and the target image is calculated as (22, 15) according to the first difference value −22 and the second difference value −15.

According to the first difference value 22 in the brightness difference value (22, 15), a first compensation value corresponding to the brightness difference value may be obtained as 0.5 of Item 2 by looking up Table 1. According to the first difference value 15 in the brightness difference value (22, 15), a second compensation value corresponding to the brightness difference value may be obtained as 3.0 of Item 3 by looking up Table 2. Then, a sum of the first compensation value 0.5 and the second compensation value 3.0 is calculated to obtain a threshold compensation value 3.5. At last, the basic threshold value is adjusted with the threshold compensation value 3.5 to obtain the recognition threshold value, thereby performing a face recognition process on the input image by using the recognition threshold value.

In this embodiment, although the illustration is given with reference to an input image and a target image with different brightness, a plurality of target images may be loaded into the storage device of the electronic device in actual applications of the face recognition process. The input image is used to perform face recognition on the target images to determine whether the input image passes the face recognition process or not.

When the method for adjusting a light source threshold value for face recognition provided by the present invention is applied to a face recognition system, the recognition threshold value for face recognition can be dynamically adjusted under different ambient light sources. No matter the ambient light is poor or the image brightness difference recorded in a database is too big, the recognition threshold value can be properly increased or decreased, so as to enable a user to successfully complete a face recognition under different environments and different lights.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for adjusting a light source threshold value for face recognition, comprising:
capturing an input image;
calculating a first brightness value of the input image;
loading a target image;
loading a second brightness value of the target image;
comparing the first brightness value with the second brightness value to obtain a brightness difference value between the input image and the target image;
adjusting a basic threshold value according to the brightness difference value to obtain a recognition threshold value; and
performing a face recognition process on the input image by using the recognition threshold value.

2. The method for adjusting a light source threshold value for face recognition according to claim 1, wherein the first brightness value comprises a brightness average value and a brightness standard deviation value of the input image, and the second brightness value comprises a brightness average value and a brightness standard deviation value of the target image.

3. The method for adjusting a light source threshold value for face recognition according to claim 2, wherein the brightness average value of the input image is calculated by using the following equation:
$$\overline{x} = \frac{1}{N} {\sum }_{i = 1}^{N} {x}_{i} ,$$
where, x̅ is the brightness average value of the input image, N is a total number of pixels of the input image, i is an i^{th} pixel of the input image, xᵢ is a brightness value of the i^{th} pixel of the input image, and N and i are positive integers.

4. The method for adjusting a light source threshold value for face recognition according to claim 3, wherein the brightness average value of the target image is calculated by using the following equation:
$$\overline{y} = \frac{1}{M} {\sum }_{j = 1}^{M} {y}_{j} ,$$
where, y̅ is the brightness average value of the target image, M is a total number of pixels of the target image, j is a j^{th} pixel of the target image, yⱼ is a brightness value of the j^{th} pixel of the target image, and M and j are positive integers.

5. The method for adjusting a light source threshold value for face recognition according to claim 2, wherein the brightness standard deviation value of the input image is calculated by using the following equation:
$$σ = \sqrt{\frac{1}{N} {\sum }_{i = 1}^{N} {( {x}_{i} - \overline{x} )}^{2}} ,$$
where, σ is the brightness standard deviation value of the input image, N is a total number of pixels of the input image, i is an i^{th} pixel of the input image, xᵢ is a brightness value of the i^{th} pixel of the input image, x̅ is the brightness average value of the input image, and N and i are positive integers.

6. The method for adjusting a light source threshold value for face recognition according to claim 5, wherein the brightness standard deviation value of the target image is calculated by using the following equation:
$$θ = \sqrt{\frac{1}{M} {\sum }_{j = 1}^{M} {( {y}_{j} - \overline{y} )}^{2}} ,$$
where, θ is the brightness standard deviation value of the target image, M is a total number of pixels of the target image, j is a j^{th} pixel of the target image, yᵢ is a brightness value of the j^{th} pixel of the target image, y̅ is the brightness average value of the target image, and M and j are positive integers.

7. The method for adjusting a light source threshold value for face recognition according to claim 1, wherein before the step of loading the target image and the step of loading the second brightness value of the target image, the method further comprises:
capturing the target image;
calculating the second brightness value of the shot target image; and
storing the shot target image and the calculated second brightness value.

8. The method for adjusting a light source threshold value for face recognition according to claim 7, wherein the brightness average value of the target image is calculated by using the following equation:
$$\overline{y} = \frac{1}{M} {\sum }_{j = 1}^{M} {y}_{j} ,$$
where, y̅ is the brightness average value of the target image, M is a total number of pixels of the target image, j is a j^{th} pixel of the target image, yⱼ is a brightness value of the j^{th} pixel of the target image, and M and j are positive integers.

9. The method for adjusting a light source threshold value for face recognition according to claim 7, wherein the brightness standard deviation value of the target image is calculated by using the following equation:
$$θ = \sqrt{\frac{1}{M} {\sum }_{j = 1}^{M} {( {y}_{j} - \overline{y} )}^{2}} ,$$
where, θ is the brightness standard deviation value of the target image, M is a total number of pixels of the target image, j is a j^{th} pixel of the target image, yᵢ is a brightness value of the j^{th} pixel of the target image, y̅ is the brightness average value of the target image, and M and j are positive integers.

10. The method for adjusting a light source threshold value for face recognition according to claim 1, wherein the step of comparing the first brightness value with the second brightness value to obtain the brightness difference value between the input image and the target image comprises:
comparing a brightness average value of the first brightness value with a brightness average value of the second brightness value to obtain a first difference value;
comparing a brightness standard deviation value of the first brightness value with a brightness standard deviation value of the second brightness value to obtain a second difference value; and
calculating the brightness difference value between the input image and the target image according to the first difference value and the second difference value.

11. The method for adjusting a light source threshold value for face recognition according to claim 1, wherein the step of adjusting the basic threshold value according to the brightness difference value to obtain the recognition threshold value comprises:
looking up a first lookup table according to the brightness difference value to obtain a first compensation value corresponding to the brightness difference value;
looking up a second lookup table according to the brightness difference value to obtain a second compensation value corresponding to the brightness difference value;
calculating a threshold compensation value according to the first compensation value and the second compensation value; and
adjusting the basic threshold value with the threshold compensation value to obtain the recognition threshold value.

12. The method for adjusting a light source threshold value for face recognition according to claim 1, wherein the step of calculating the threshold compensation value according the first compensation value and the second compensation value comprises:
summing the first compensation value and the second compensation value to obtain the threshold compensation value.

13. The method for adjusting a light source threshold value for face recognition according to claim 1, wherein the first compensation value is associated with a brightness average value of the input image, and the second compensation value is associated with a brightness standard deviation value of the input image.

14. The method for adjusting a light source threshold value for face recognition according to claim 1, wherein before the step of adjusting the basic threshold value, the method further comprises:
setting the basic threshold value.

15. The method for adjusting a light source threshold value for face recognition according to claim 1, wherein the face recognition process comprises:
detecting a first face block in the input image;
detecting a second face block in the target image;
calculating the detected first face block and the detected second face block to obtain an image similarity value; and
comparing the recognition threshold value with the image similarity value to determine whether the input image passes the face recognition process or not.
